(19) United States
(12) Patent Application Publication
(10) Pub. No.: US 2005/0071951 A1
(43) Pub. Date: Apr. 7, 2005

(54) Handle extender

(76) Inventor: Charles David Joesten, Arlington, VA (US)

Correspondence Address: CHARLES JOESTEN, 1276 NORTH WAYNE STREET, #1208, ARLINGTON, VA, 22201, US

(21) Appl. No.: 10/676,492

(22) Filed: Oct. 2, 2003

(51) Int. Cl. E05B 1/00

(52) U.S. Cl. 16/114.1

(57) ABSTRACT

This invention is directed to assist users of hand-carried, wheeled luggage in maintaining extraordinary lateral and obstruction-free use of the wheeled object without the problems associated with conventional wheeled luggage handle assemblies. The intent of the attachment device is to create enough lateral clearance between the user's body, legs, and feet and the luggage piece or handle framework to provide this obstruction-free use.

### CROSS-REFERENCE TO RELATED PATENTS

U.S. Pat. No. 6,578,231

U.S. Pat. No. 6,301,746

U.S. Pat. No. 5,722,118

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The field of endeavor for this invention is in the class of a handle for wheeled objects, such as hand-carried luggage or wheeled carts. The recommended U.S. Patent classification for Miscellaneous Hardware is 16, the sub-classification for Handle, Handle Component, or Handle Adjunct is 110.1, and the sub-classification for Detachable Handle is 422. As this device is not a piece of hand-carried luggage in and of itself, it falls under the sub-classification of Detachable Handle as a handle attachment to a piece of Hand-carried Luggage.

Some prior wheeled travel bags having extendable and retractable handle assemblies and attachments have been proposed and numerous patents have been issued to address the challenge of wheeled luggage handle configuration. The following is a list patents directed to this topic and related topics:

1. U.S. Pat. No. 5,722,118, granted Mar. 3, 1998, “Handle Conversion Apparatus,” Hansen et al.;

2. U.S. Pat. No. 6,301,746, granted Oct. 16 2001, “Telescoping-Handle Assembly For Luggage And Other Luggable Items,” Myers et al.;

3. U.S. Pat. No. 6,578,231, granted Jun. 17, 2003, “Luggage Handle,” Godshaw et al.

The example in number 1 above is typical of many wheeled luggage objects, with an extendable and retractable handle assembly that is longitudinal in nature to the length of the bag and therefore rigid and difficult to manipulate without discomfort to the user. The examples in numbers 2 and 3 above are attachments that extend the length of the fixed luggage handle assembly, but neither addresses the difficulty and discomfort associated with the proximity of the user to the forward motion of the wheeled object from a lateral perspective.

The luggage marketplace has been saturated with hand-carried, wheeled objects, and new requirements have become apparent in their design. Nearly every wheeled bag has an extendable and retractable handle frame with attached handle. However, given the angle of the bag when the handle is extended and in use (tilted forward approximately 45 degrees to the surface where it is rolling), limitations are evident in terms of proximity of the respective user. Different users have different requirements for navigating a wheeled object, particularly due to their personal body type, posture, and preference. For example, if the user is of a particularly tall or short height, or someone with a particularly long or wide stride, the normal pulling configuration is cumbersome and even restrictive. Restrictions include the user's feet or legs bumping into the piece of luggage and disrupting its roller track, potentially causing the piece to fall over and cause injury. User fatigue in the hand, wrist, arm, and shoulder are also possible, given the strain put on these extremities in order to manipulate the wheeled luggage away from the body. One sign of this type of disadvantaged operation is when the wheeled piece of luggage appears to be swerving back and forth behind the user. This is due to strain on the shoulder and to the user trying to avoid hitting their feet on their aft stride. Consequently, the proposed device serves as a solution to these problems as an attachment to current wheeled bags and similar hand-carried objects.

### BRIEF SUMMARY OF THE INVENTION

This invention is directed to correct the problems noted in the Background section and assist the user of hand-carried luggage in maintaining obstruction-free use of a wheeled object. The intent of the attachment device is to create enough lateral clearance between the user's body, legs, and feet and the luggage piece or handle framework to provide this obstruction-free use.

One innovative design of this device is the lateral proximity to the wheeled object fixed handle assembly with which it is used. When attached to the upper extremity of the handle assembly, just under the fixed handle, the device then extends the handle gripping area towards the user's body. Depending on the width of the fixed handle assembly, the extended gripping area is still several inches. While this device extends laterally from the handle assembly, allowing for more gripping area for the user, it typically does not extend beyond the entire width of the wheeled object and therefore does not restrict the normal operation of the object through doorways or security screening apparatus.

Another innovative feature of this device is the range of motion it provides the user in manipulating a wheeled object in normal operations. The extra gripping area, extended laterally from the fixed handle assembly, allows a user to grip the extension and pull or push the wheeled object with a more relaxed angle of the wrist and attitude of the arm. This increased range and relaxed grip allows the user to manipulate the wheeled device further from their body and extremities in motion during a stroll or brisk walk. Feet, thighs, and hips are well distanced from the wheeled object while using the extension, allowing the user to retain a more natural physical stance and posture, operate an even greater pace than normal if necessary, and maintain control and movement of the object.

Additional innovative aspects of this device are the ease of use and adaptability to currently used wheeled objects. The device fits securely to any wheeled object handle assembly and is relatively easy to attach and detach in only a few short steps. The user fits the forked end of the device to the handle assembly support member furthest from their body, rests the device along the handle assembly support member closest to their body, and then secures the device to the assembly. Securing the device involves pulling the horizontally-configured attached strap across the opposite side of the device, with the assembly support members enclosed, threading the strap though a looped eyelet attached to the device, then wrapping the strap back on itself and securing it with a self-adhesive strip along the strap. Second, a vertically-configured attached strap near the center of the device is wrapped around the device, fixed handle, and horizontal strap, and then secured to itself with a self-adhesive strip along the strap. The strength of the attached device allows for a completely secure fit to the fixed handle assembly and allows for normal operations of the wheeled object, even at odd angles maintained during transport. Additionally, the vertical strap can be used to secure a second luggage piece to the fixed handle, allowing a more secure load when traveling with multiple pieces. The basic nature of the device allows for use with most any handle assembly at a relatively inexpensive cost to the user. It is made up of only a few inexpensive yet durable materials. Users can continue to use their currently owned wheeled luggage with this device, attaching and removing it as necessary given operational situations presented in travel and transport, such as security checkpoints or storage in overhead or vehicle compartments.

### BRIEF DESCRIPTION OF THE SEVERAL VIEWS OF THE DRAWINGS

FIG. 1 is an illustration of a wheeled luggage case with a fully extended handle assembly and the Handle Extender attached to the fixed handle assembly.

FIG. 2 is another view of the Handle Extender attached to a fixed handle assembly of a wheeled luggage object. The view is the outside view, where the side shown would face up as the wheeled object is being pulled forward.

FIG. 3 is a view of the Handle Extender in place on a fixed handle assembly of a wheeled luggage object. The device has not yet been secured to the fixed handle assembly as the straps have not been secured. The view is the inside view, where the side shown would face down to the ground as the wheeled object is being pulled forward.

FIG. 4 is a computer-generated illustration of the Handle Extender not yet secured to a luggage object. This top section view highlights the forked mounting base and self-adhesive strips.

FIG. 5 is an exploded view of the Handle Extender in pre-assembled form.

FIG. 6 is an alternative representation of functionality of the invention, with a modification for a collapsible handle gripping area where the actual grip can be folded horizontally to the side of the invention.

### DETAILED DESCRIPTION OF THE INVENTION

In order to emphasize particular embodiments and innovative aspects of the invention, a number of figures of different perspectives are shown. For ease of interpretation, all numbers used to label particular aspects of the invention are used consistently across each figure for that same aspect.

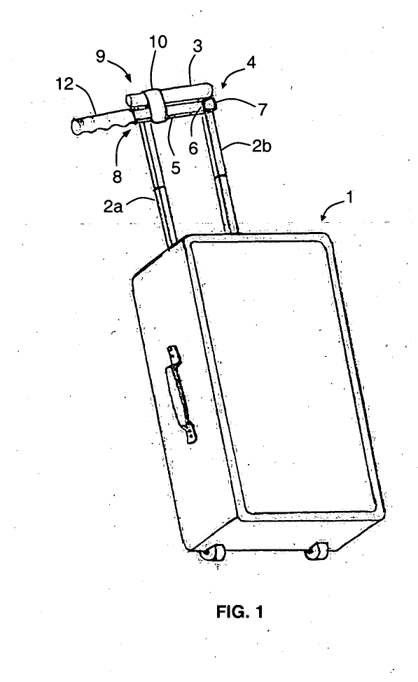

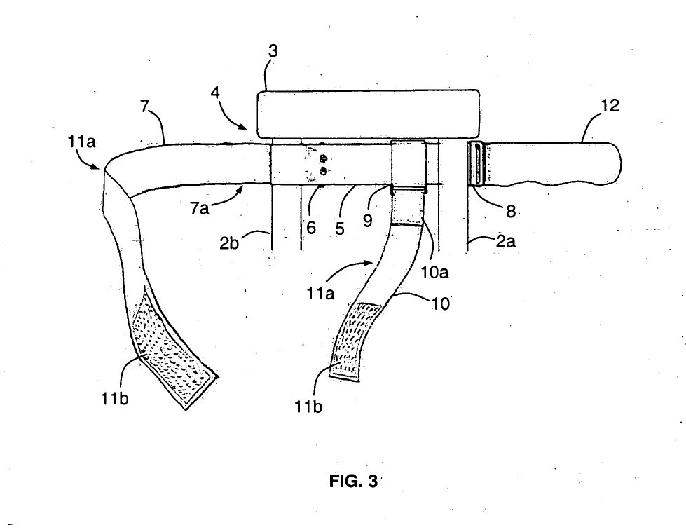

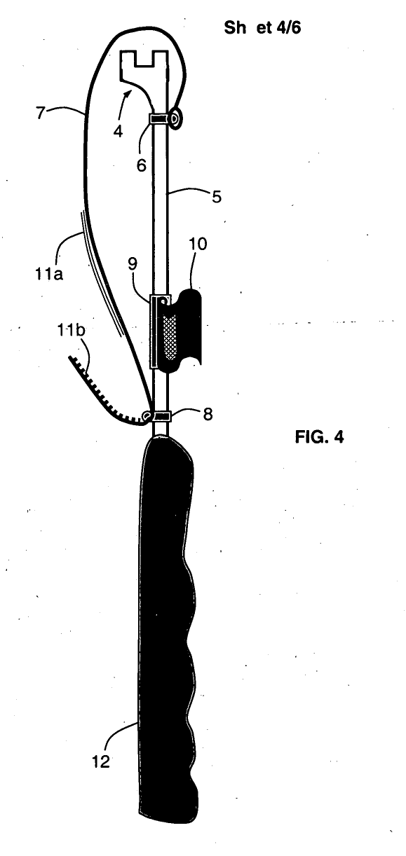

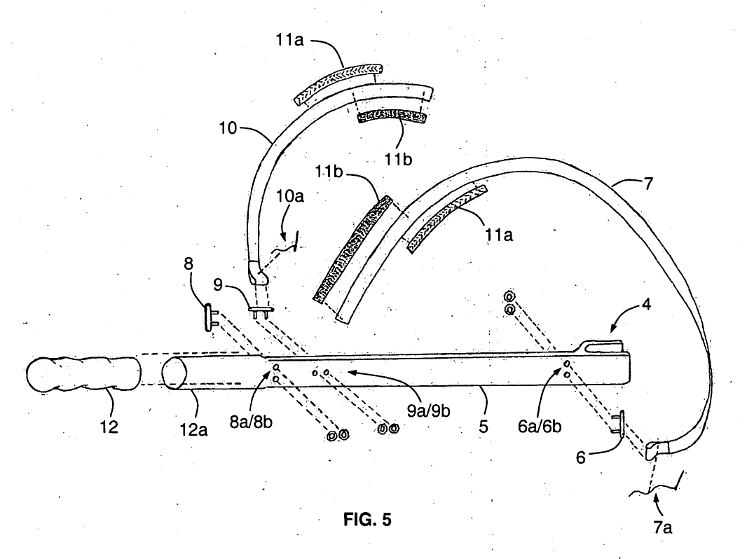

In FIG. 1, a wheeled luggage case 1 is depicted with the telescopic handle assembly fully extended. The telescopic handle assembly is made up of two telescopic support members 2a/2b that connect to a fixed handle 3, all of which is attached permanently to the wheeled case 1. The telescopic handle assembly can be extended out from or retracted into the wheeled case. Because the supporting members are attached to the handle 3 at the top and to the wheeled case at the bottom, the entire telescopic assembly is quite rigid. Also shown in this figure is the invention attached to the fixed handle assembly and ready for use. The base end 4 of the invention is forked with two protruding prongs (detailed in FIG. 4 and FIG. 5) that allow a fit around one base support member 2b of a luggage handle. The prongs will fit from the inside of said member on the side furthest from the user 2b. On the main body 5 of the invention, just inside of the base end prongs 4, there is an attached strap connector 6 (detailed in FIG. 3 and FIG. 5). This connector secures the horizontal strap 7 (detailed in FIG. 3 and FIG. 5) to the invention main body. Opposite the base end of the invention next to the handle extension grip 12 is a second fixed strap connector 8 (not visible in this view) that is used for fastening the loose end of the horizontal strap. This looped clasp will be detailed in FIG. 3 and FIG. 5, but is used to loop the horizontal strap 7 through and then secure it to itself using self-adhesive strips. On the center section of the invention main body 5, a vertical strap connector 9 (not visible in this view) is fastened to the main body and serves as the base for the vertical strap 10 (detailed in FIG. 3 and FIG. 5). Once the invention is in place and the horizontal strap 7 is secure, the user then wraps the vertical strap 10 tightly around the fixed luggage handle 3 and presses the self-adhesive to itself for ultimate security. Finally, the handle grip 12 of the invention is shown to extend laterally from the fixed handle assembly, close to the user.

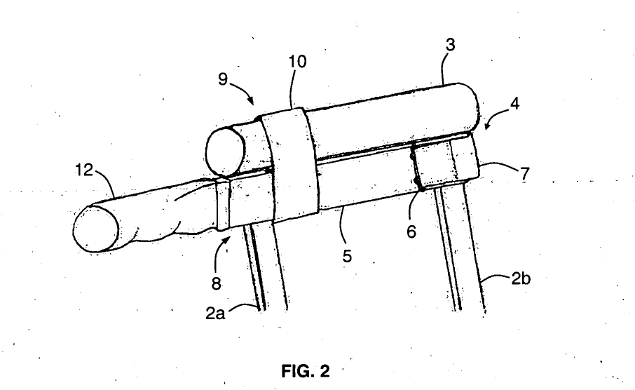

In FIG. 2, a close-up view of the invention is shown from the same vantage point as in FIG. 1, the outer side of the handle assembly. Again, the illustration depicts the telescopic handle assembly fully extended, however only the top portions of the support members 2a/2b are shown. In this example, the supporting members are fully extended and attached to the fixed handle 3. Also shown in this figure is the invention attached to the fixed handle assembly and ready for use. As in FIG. 1, the base end 4 of the invention is forked with two protruding prongs (detailed in FIG. 4 and FIG. 5) that allow a fit around one base support member 2b of a luggage handle. The prongs will fit from the inside of said member on the side furthest from the user 2b. On the main body 5 of the invention, just inside the base end prongs 4, there is an attached strap connector 6 (detailed in FIG. 3 and FIG. 5). This connector secures the horizontal strap 7 (detailed in FIG. 3 and FIG. 5) to the main body of the invention. Opposite the base end of the invention next to the handle extension grip 12 is a second fixed strap connector 8 (not visible in this view) that is used for fastening the loose end of the horizontal strap. This looped clasp will be detailed in FIG. 3, but is used to loop the horizontal strap through and then secure it to itself using self-adhesive strips. On the center section of the invention main body 5, a vertical strap connector 9 (not visible in this view) is fastened to the main body and serves as the base for the vertical strap 10 (detailed in FIG. 3 and FIG. 5). Once the invention is in place and the horizontal strap 7 is secure, the user wraps the vertical strap 10 tightly around the fixed luggage handle 3 and presses the self-adhesive to itself for ultimate security. Finally, the handle extension grip 12 of the invention is shown to extend laterally from the fixed handle assembly, close to the user.

In FIG. 3, an exploded view from the inner side of the handle assembly is shown. It should be noted that the invention support straps are not secured so as to show the configuration of said straps and respective anchoring connectors. The forked base end 4 of the invention is positioned against one base support member 2b of a luggage handle. The prongs fit from the inside of said member, just under the fixed handle 3, and on the side furthest from the user 2b. On the outermost prong in line with the main body 5 of the invention, just inside the base end prongs 4, there is an attached strap connector 6 (detailed in FIG. 3 and FIG. 5). This connector resembles a clasp with an opening width-wise on the edge to allow a cloth strap to be inserted, threaded through, and sewn to itself permanently 7a (not shown in this view). This connector serves as the base for the horizontal strap 7 attachment that provides a secure hold of the invention to the luggage handle assembly. Next to the handle grip of the handle extension 12 is the second strap connector 8 for the horizontal strap. In the middle section on the outside of the horizontal strap is sewn a region of looped self-adhesive 11a (the softer of the self-mating components, but not shown in this view) that spans nearly the entire length of the middle section of the strap. Also on the outside edge near the end of the horizontal strap is sewn the hooked self-adhesive 11b (the rougher of the self-mating components). This looped horizontal connector 8 is where the loose end of the horizontal strap is threaded through and then attached back onto itself using the self-adhesives. Due to varying widths of the base support members of wheeled luggage pieces, albeit only a few inches in length, the invention main body 5 and horizontal attachment strap 7 will be long enough to accommodate these varying lengths, while still providing a secure fit to the fixed handle assembly. On the center section of the invention main body 5, another strap connector is fastened with the slit opening horizontally to the bottom side of the main body (detailed in FIG. 3 and FIG. 5). This vertical strap connector 9 also resembles a clasp with an opening width-wise on the edge to allow for a cloth strap to be inserted, threaded through, and sewn to itself permanently 10a. Attached to the vertical connector is the vertical fastening strap 10. In the middle section on the outside of the vertical strap is sewn a region of looped self-adhesive 11a (the softer of the self-mating components, but not shown in this view) that spans nearly the entire length of the middle section of the strap. On the inside of the end of the vertical strap is sewn the hooked self-adhesive 11b (the rougher of the self-mating components). Once the invention is in place and the horizontal strap is secure, the user wraps the vertical strap 10 tightly around the luggage handle and presses the self-adhesive to itself for ultimate security. Finally, the handle grip 12 of the invention is shown to extend laterally from the fixed handle assembly, close to the user.

FIG. 4 is a computer-generated drawing of the top view perspective of the invention. Without repeating the detail in the previous illustrations, the main aspects will be noted but the forked base end 4 will be the focus of this drawing. In this view, the handle extender grip 12 is shown at the bottom of the drawing. Moving up, the horizontal looped connector 8 is shown where the horizontal strap 7 loops through and attaches itself using self-adhesives 11a/11b. Continuing up the main body 5 of the invention, the vertical strap connector 9 is shown with attached vertical strap 10. At the top Of this drawing is the forked base end 4 of the invention. As mentioned in previous drawings, just inside the forked base end, the horizontal strap connector 6 is attached to the main body. This forked base end fits around the handle assembly support member furthest from the user and then the horizontal and vertical straps are used to secure the invention to the handle assembly. Of note in this drawing are the self-adhesive strips on the horizontal strap, where the hooked 11b adhesive fits through the horizontal connector and attaches to the soft adhesive 11a.

FIG. 5 is an exploded view of the invention in pre-assembled form. Each of the component parts is emphasized in this view with motion lines to show the assembly configuration. The main body 5 of the invention is one solid piece of solid and study material where all other components are attached. The main body 5 is molded or formed from wood, metal, or most likely hardened plastic. Solid plastic will provide the necessary strength for the handle extender and be less of a security risk with regard to airport security procedures. One end of the main body 5 is where the forked base end 4 is molded. On the opposite end of the main body 5 the rectangular and relatively flat structure of the main body is then molded into a rounded, cylindrical end 12a. On the main body, just inside of this rounded end 12a are two predrilled holes 8a/8b to house the horizontal looped strap connector 8. Moving further toward the center of the main body 5 of the invention, two more predrilled holes 9a/9b house the vertical strap connector 9. To assemble the Handle Extender, the horizontal looped strap connector 8 is inserted into the predrilled holes 8a/8b and two threaded nuts are screwed onto the connector to secure it tightly to the main body 5. The vertical looped strap connector 9 is inserted into its predrilled holes 9a/9b and then similarly attached tightly to the main body with threaded screws. The horizontal base strap connector 6 is inserted into its predrilled holes 6a/6b and fastened tightly to the main body 5. The horizontal strap 7 is threaded through the horizontal base strap connector 6, folded back onto itself, and sewn securely together 7a. The vertical strap 10 is similarly threaded through the vertical strap connector 9, folded back onto itself, and sewn securely together 10a. In the middle section on the outside of the horizontal strap 7 is sewn a region of looped self-adhesive 11a (the softer of the self-mating components) that spans nearly the entire length of the middle section of the strap. On the end of the horizontal strap 7, on the same side as the looped self-adhesive 11a, is sewn the hooked self-adhesive 11b (the rougher of the self-mating components). In the middle section on the outside of the vertical strap 10 is sewn a region of looped self-adhesive 11a (the softer of the self-mating components) that spans nearly the entire length of the middle section of the strap. On the inside of the end of the vertical strap 10 is sewn the hooked self-adhesive 11b (the rougher of the self-mating components). Note that on the vertical strap 10, the looped self-adhesive 11a and hooked self-adhesive 11b are on opposite sides of the vertical strap 10 as the strap is wrapped around and then secured to the fixed handle (not shown in this view) of the luggage handle assembly. Finally, a plastic or rubber molded grip 12 is slid securely onto the rounded end of the main body 5 of the invention. Depending on the security of the fit of the grip 12 to the rounded end, some type of glue or adhesive may be necessary to ensure a permanent fit.

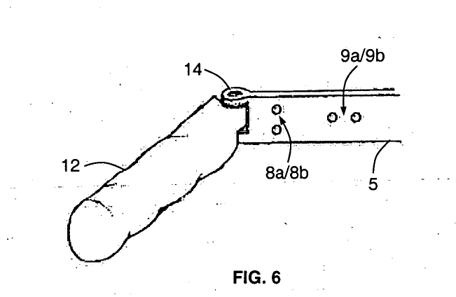

FIG. 6 is an alternative representation of functionality of said invention, with a modification for a collapsible handle gripping area where the actual grip can be folded horizontally to the side of the invention. In order to provide more convenient performance for the traveler, an alternate handle extension assembly can be constructed in accordance with the present invention. As shown, the main body 5 of the invention is identical to that described in previous figures, with the exception of a hinge 14 behind the gripping surface 12 and between the gripping surface and horizontal looped strap connector predrilled holes 8a/8b. This hinge 14 allows the user to fold the gripping area 12 of the invention to one side and flush with the main body 5, opposite the side of the main body where the horizontal looped strap connector 8 and vertical strap connector predrilled holes 9a/9b are located. The advantage of this folded configuration is that the traveler can minimize any obstruction of the handle 12 while loading and unloading the luggage piece 1, into airport security scanners or airplane overhead compartments for example, without detaching the invention altogether.

The drawings described highlight many of the unique features of this invention. Particularly, the ease of use is demonstrated in the simple attachment procedure of fitting the invention's forked base onto the handle assembly supports, threading each of the straps and securing the adhesives, and gripping the handle extension. The invention is compact, just more than twice the length of a typical fixed handle, and also durable, with only a few component parts required for assembly. The invention as described provides the added lateral clearance from wheeled objects for users to achieve a greater and freer range of motion when in use.

1. A luggage item attachment comprising, in combination:
a rigid and solid main body made of hardened plastic or composite, molded to be fitted with a handle gripping surface on one end and molded with a forked end on the opposite side of the main body, and predrilled holes on the main body inside the handle area and forked end for mounting connection clasps;
three permanently attached connection clasps, two inside the handle end of the main body and the third near the forked end of the main body;
two flat, elongated, and flexible straps, each permanently attached to a connection clasp by one strap end with the other strap end loose, one attached on the clasp near the handle end of the main body and the other to the clasp at the forked end of the main body, and each strap having permanently attached self-adhesives on the mid and end sections of the strap itself; and
a gripping surface on one end of this device, either molded for ergonomic gripping purposes, as in the contour of a hand, or fitted with a rubberized or plastic gripping surface.

2. The luggage item attachment as in claim 1 where the device is attached by:
placing the forked end against the outer distal member of a telescopic handle assembly of a wheeled luggage item, wrapping the strap next to the forked end around the same distal member, threading it through the third connection clasp next to the handle and securing it to itself by aligning the self-adhesive material;
wrapping the second strap end around the permanent handle grip of the luggage item handle assembly until tight, and then securing it to itself by aligning the self-adhesive material.

3. A luggage item attachment as in claim 2 where the device can be securely fastened to the telescopic handle assembly of a wheeled luggage item so that it can be used on either the left or right side of the luggage item to provide extra lateral clearance between the wheeled luggage item and the right or left-handed user's body, respectively.

4. A luggage item attachment as in claim 2 where the device will withstand the load and distributed weight of the wheeled luggage item while in use, will have minimal slippage, and will not jeopardize the structural integrity of the device or luggage item.

5. A luggage item attachment as in claim 2 where the device fits securely to telescopic handle assemblies or distal telescopic members of varying widths.

6. A luggage item attachment comprising, in combination:
a rigid and solid main body made of hardened plastic or composite, molded to be fitted with a handle gripping surface on one end and molded with a forked end on the opposite side of the main body, and predrilled holes on the main body inside the handle area and forked end for mounting connection clasps;
three permanently attached connection clasps, two inside the handle end of the main body and the third near the forked end of the main body;
two flat, elongated, and flexible straps, each permanently attached to a connection clasp by one strap end with the other strap end loose, one attached on the clasp near the handle end of the main body and the other to the clasp at the forked end of the main body, and each strap having permanently attached self-adhesives on the mid and end sections of the strap itself;
a gripping surface on one end of this device, either molded for ergonomic gripping purposes, as in the contour of a hand, or fitted with a rubberized or plastic gripping surface;
a luggage item that is attached to a telescopic handle assembly of a wheeled luggage item by placing the forked end against the outer distal member of a telescopic handle assembly of a wheeled luggage item, wrapping the strap next to the forked end around the same distal member, threading it through the third connection clasp next to the handle and securing it to itself by aligning the self-adhesive material, wrapping the second strap end around the permanent handle grip of the luggage item handle assembly until tight, and then securing it to itself by aligning the self-adhesive material;
a luggage item attachment that, when securely fastened to the telescopic handle assembly of a wheeled luggage item, can be used on either the left or right side of the luggage item to provide extra lateral clearance between the wheeled luggage item and the right or left-handed user's body, respectively;
a luggage item attachment that, when securely fastened to the telescopic handle assembly of a wheeled luggage item, will withstand the load and distributed weight of the wheeled luggage item while in use, will have minimal slippage, and will not jeopardize the structural integrity of the device or luggage item; and
a luggage item attachment that will fit securely to telescopic handle assemblies or distal telescopic members of varying widths.
